(19) United States
(12) Patent Application Publication
(10) Pub. No.: US 2013/0157513 A1
(43) Pub. Date: Jun. 20, 2013

(54) TWO-TERMINAL RADIAL CONNECTOR

(71) Applicants: Christian Hagen, Lewistown, IL (US); Paul Casperson, Peoria, IL (US); Joseph Burkiett, Fairview, IL (US)

(72) Inventors: Christian Hagen, Lewistown, IL (US); Paul Casperson, Peoria, IL (US); Joseph Burkiett, Fairview, IL (US)

(73) Assignee: Caterpillar Inc., Peoria, IL (US)

(21) Appl. No.: 13/330,725

(22) Filed: Dec. 20, 2011

(51) Int. Cl. H01R 33/06

(52) U.S. Cl. 439/638

(57) ABSTRACT

The disclosure relates to an electrical connector that allows for universal radial orientation when connected to a two-pole electrical device. The two-pole electrical device that the connector mates to is also disclosed. The mating connector is fastened to the two-pole electrical device in a way to ensure secure connection in automotive and heavy duty applications.

### TECHNICAL FIELD

The disclosure is directed to an electrical connector for a two-pole electrical device, more particularly to the connector terminals and orientation of the terminals of a two-pole electrical device.

### BACKGROUND

Connectors for two pole electrical devices are commonly used throughout the electrical arts. Examples of two-pole electrical devices are switches, capacitors, resistors, batteries, solenoids, relays, or other devices known in the art. Each of these two-pole electrical devices requires a wire connection. The wire connection is achieved by attaching the wire to a terminal of the two-pole electrical device. See for example Solenoid Stator Assembly for Electronically Actuated Fuel Injector to Anh Pham, U.S. Pat. No. 5,339,063.

One problem with the commonly used two-terminal design is that of connector orientation. Depending on the installed orientation of the two-pole electrical device, the mating connector and harness may be required to be twisted in order to make a proper connection. Twisting the harness may cause undesired stress on the harness and connector components, leading to premature failure.

### SUMMARY OF THE INVENTION

In one aspect of the disclosure, an electrical connector for a two-pole electrical device is disclosed. The device includes center terminal including a center terminal hole and a center terminal mating surface, an outer terminal including an outer terminal hole and an outer terminal mating surface, wherein said outer terminal hole are aligned axially and said center terminal and said outer terminal are separated by insulator.

### BRIEF DESCRIPTION OF THE DRAWINGS

FIG. 1 is a view of an electrical connector for a two-pole electrical device

FIG. 2 is a view of a two-pole electrical device

FIG. 3 shows an electrical connector mated to a two-pole electrical device

FIG. 4 is a side view of an electrical connector mated to a two-pole electrical device

FIG. 5 is a bottom a view of an electrical connector for a two-pole electrical device

FIG. 6 shows another example of an electrical connector mated to a two-pole electrical device

FIG. 7 is a side view of an electrical connector from FIG. 6 mated to a two-pole electrical device

FIG. 8 is a bottom a view of an electrical connector from FIG. 6 for a two-pole electrical device

FIG. 9 shows another example of an electrical connector mated to a two-pole electrical device

FIG. 10 is a side view of an electrical connector from FIG. 9 mated to a two-pole electrical device

FIG. 11 is a bottom a view of an electrical connector from FIG. 9 for a two-pole electrical device

FIG. 12 shows a threaded fastener for joining an electrical connector mated to a two-pole electrical device

FIG. 13 shows a fastener clip for joining an electrical connector mated to a two-pole electrical device

FIG. 14 is a detailed view of the features of an electrical connector mated to a two-pole electrical device

### DETAILED DESCRIPTION

The mating connector 45 shown in FIG. 1 consists of a center terminal 50 and an outer terminal 60. The center terminal 50 and outer terminal 60 include center terminal holes 51 and 61 respectively. The center terminal 50 and outer terminal 60 are radially aligned about center holes 51 and 61 and are separated by insulator 70. Terminals 50 and 60 may be located on the same plain or offset on different plains. Terminals 50 and 60 may be attached to insulator 70. Center terminal 50 may include a connection feature 57 that conductively attaches to a first wire conductor 160. Likewise, outer terminal 60 may include a connection feature 67 that conductively attaches to a second wire conductor 170.

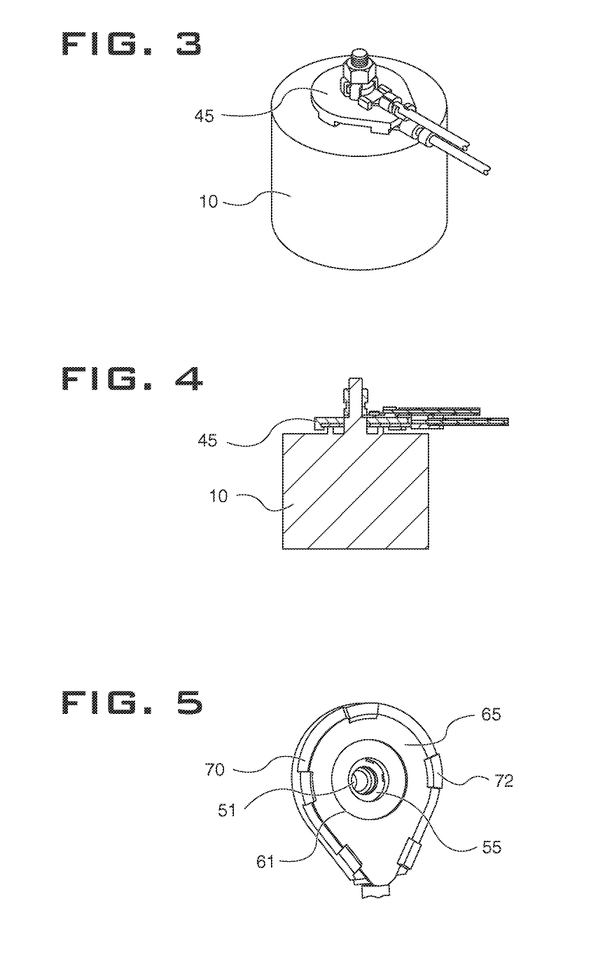

In one example of the disclosure, shown in FIGS. 3, 4, and 5, terminals 50 and 60 are attached to insulator 70 in a press-fit relationship via press fit features 72. Center terminal connection feature 57 and outer terminal connection feature 67 may be radially aligned or aligned in different orientations from each other. Terminal 50 may be attached to insulator 70 in a press-fit relationship via press fit features 72.

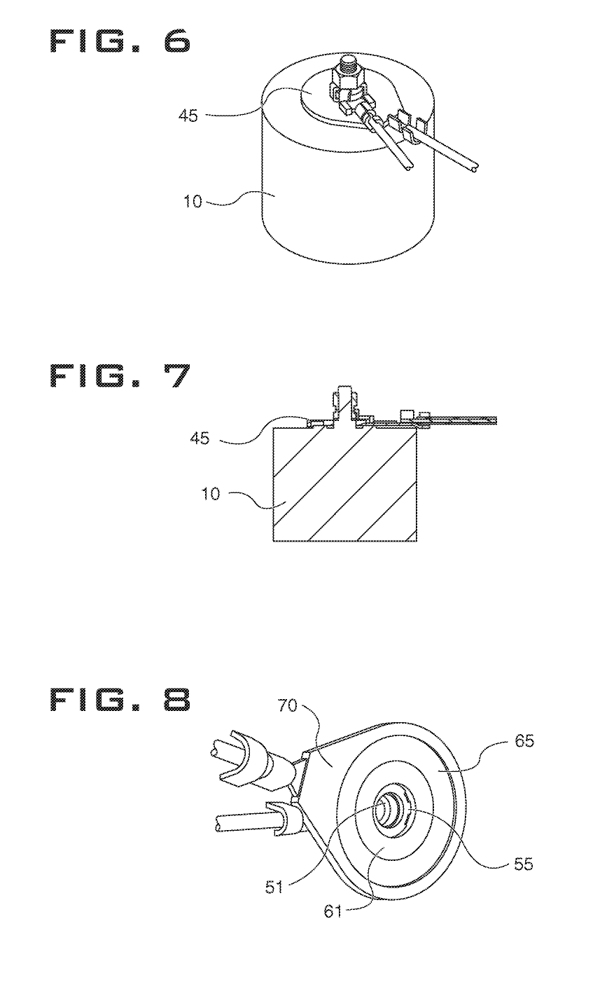

In another example of the disclosure, shown in FIGS. 6, 7, and 8, outer terminal 60 is attached to insulator 70 via an overmold process. Thus, insulator 70 captures outer terminal 60 but leaves outer terminal mating surface 65 exposed.

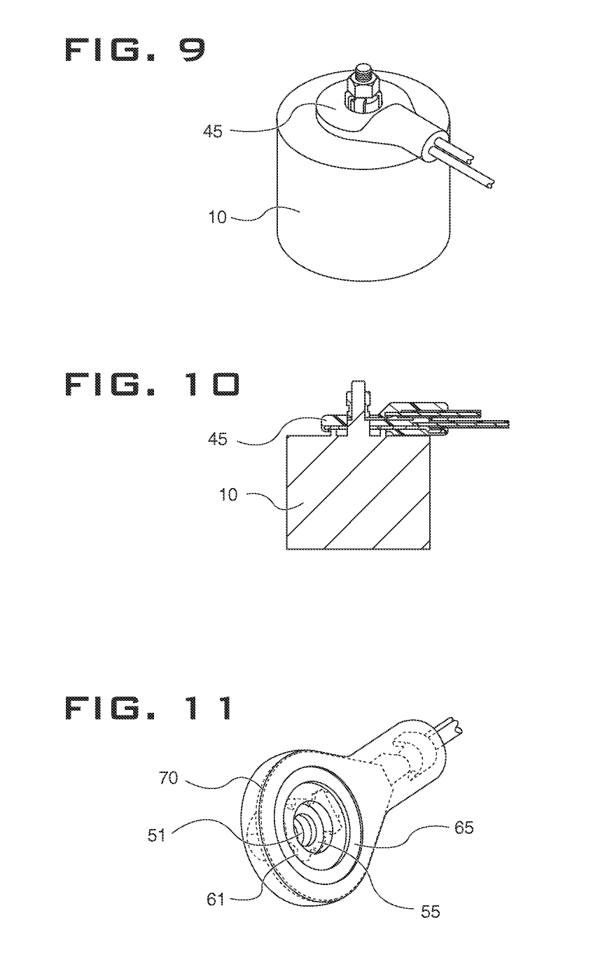

In yet another example of the disclosure, shown in FIGS. 9, 10, and 11, terminals 50 and 60 are attached to insulator 70 via an overmold process. Thus, insulator 70 captures both center terminal 50 and outer terminal 60. Center terminal mating surface 55 and outer terminal mating surface 65 are left exposed. Center terminal connection feature 57 and outer terminal connection feature 67 are shown as radially aligned to simplify the overmold process.

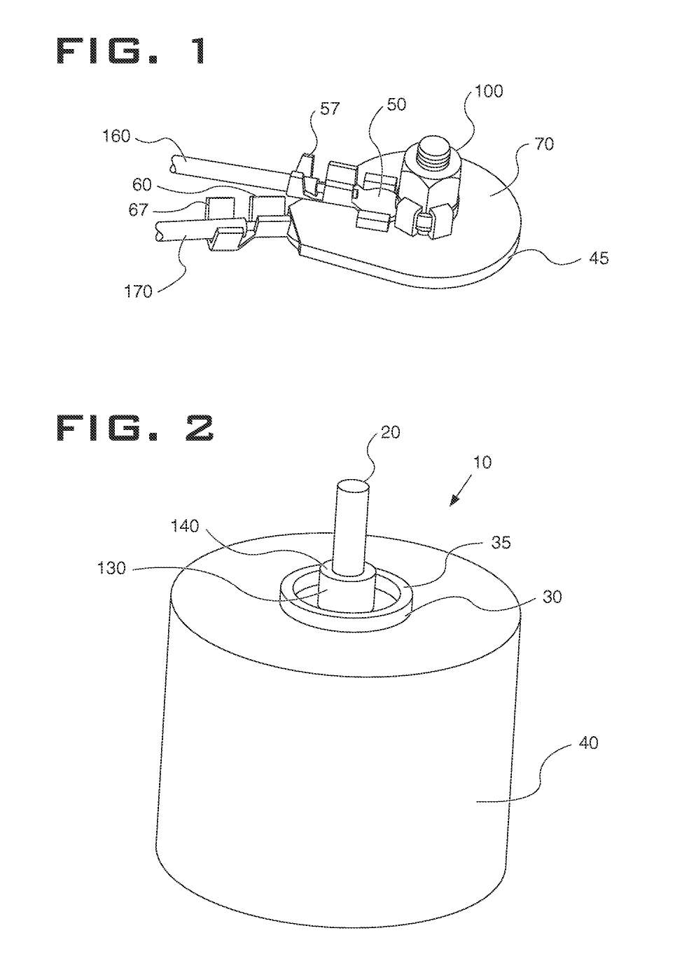

The mating connector 45 is designed to be joined to a two-pole electrical device 10, shown in FIG. 2. The internal components of the device could be a switch, capacitor, resistor, battery, solenoid, relay, or other device known in the art. The details of the internal components are not relevant to this disclosure and will not be discussed further.

The case 40 is made from a non-conducting material such as plastic and serves to provide electrical insulation between the center conductor 30 and outer conductor 40. The case could be assembled from multiple pieces or constructed as an overmold of the internal components. The overmold could consist of such materials as urethane, polyimide hot-melt, polyester, or ABS.

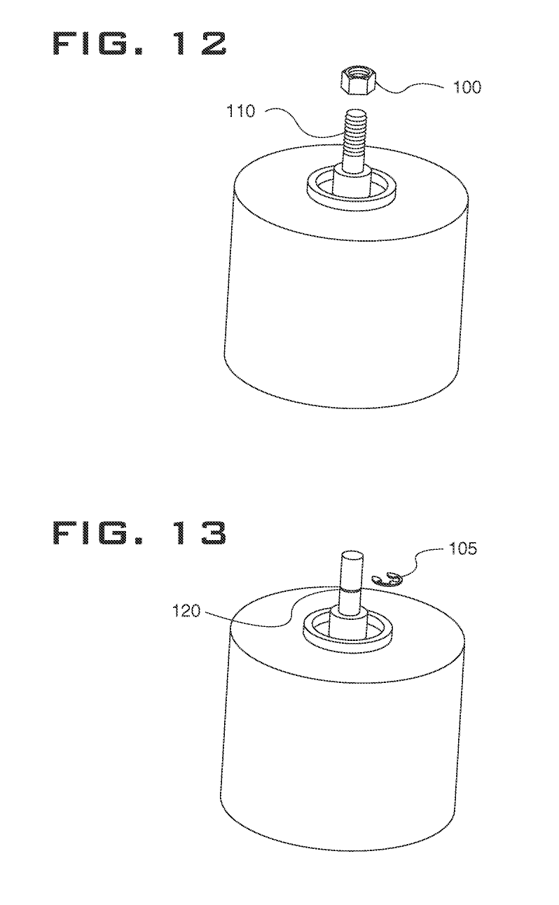

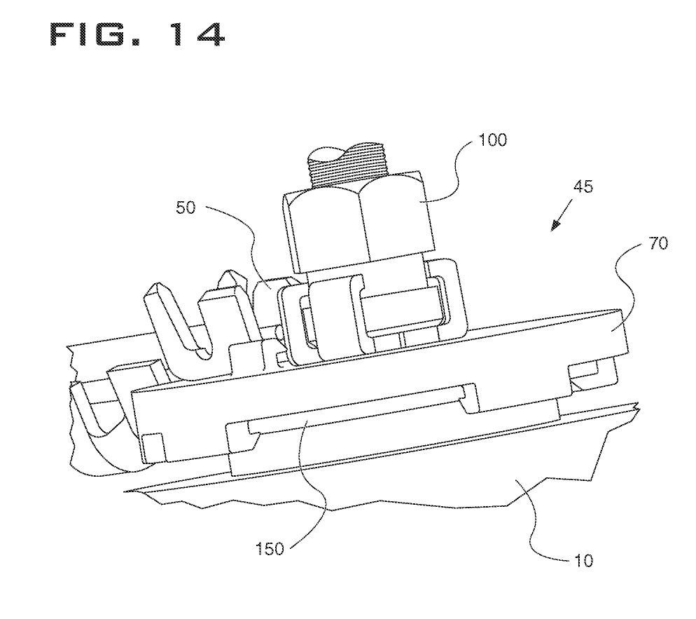

The center conductor 20 and outer conductor 30 are made of conductive material and serve to conductively transmit current from the wire conductors 160 and 170 to the internal components of the two-pole electrical device 10. The center conductor 20 takes the form of a post and is provided with a means for fastening to a mating connector 45. One method for fastening, shown in FIG. 12, is to provide threads 110 in the center conductor that mate to a threaded fastener 100 such as a nut. Another method for fastening, shown in FIG. 13, is to provide a radiused slot, or chamfer, 120 in the center conductor that mates with a fastening clip 105. Other fastening methods known in the art could also be used. The center conductor 20 could also have a larger diameter lower conductor portion 130 which has a lower conductor portion land 140. The lower conductor portion 130 provides additional strength to the center conductor, if needed. The lower conductor portion land 140 provides additional surface area for clamping load and electrical conduction.

The outer conductor 30 is radially disposed about the center conductor. The portion protruding above the case 40 has a generally cylindrical cross section. The top of the cylindrical cross section forms the outer conductor mating surface 35. The outer conductor is conductively connected to one of the poles of the internal component housed in the case 40.

Once the conductors 20, 30 of the two-pole electrical device 10 and the mating connector 45 have been joined, they are fastened into place by a fastener clip 105, a threaded fastener 100, or the like. The features of the two-pole electrical device 10 and the mating connector 45 have been chosen provide a secure connection in the vibration and shock of automotive and heavy duty applications.

### INDUSTRIAL APPLICABILITY

An example of a two-pole electrical device 10 set forth in this disclosure may be a solenoid for actuating a fuel injector. Such solenoids typically have two conductors 20, 30 for connecting to the mating connector 45. The two-pole electrical device 10 and mating connector 45 set forth in this disclosure allows for changes in the solenoid mounting orientation without need to twist the mating connector 45 in order to make the connection. This allows the conductors 160, 170 to be routed according to their design (clearance, vibration, etc.) without the concern of twisting to mate to the solenoid.

What is claimed is:

1. An electrical connector for a two-pole electrical device comprising:
A center terminal including a center terminal hole and a center terminal mating surface,
an outer terminal including an outer terminal hole and an outer terminal mating surface,
wherein said outer terminal hole are aligned axially and said center terminal 50 and said outer terminal are separated by insulator.

2. The electrical connector of claim 1 wherein said center terminal and said outer terminal are non-planar.

3. The electrical connector of claim 1 wherein said insulator engages said outer terminal in a press-fit relationship.

4. The electrical connector of claim 3 wherein said center terminal 50 and said outer terminal are non-planar.

5. The electrical connector of claim 4 wherein a center terminal connection feature 57 and an outer terminal connection feature are radially aligned.

6. The electrical connector of claim 4 wherein a center terminal connection feature and an outer terminal connection feature are radially unaligned.

7. The electrical connector of claim 1 wherein said insulator is molded over said outer terminal.

8. The electrical connector of claim 7 wherein said center terminal and said outer terminal are non-planar.

9. The electrical connector of claim 8 wherein a center terminal connection feature and an outer terminal connection feature are radially aligned.

10. The electrical connector of claim 8 wherein a center terminal connection feature and an outer terminal connection feature are radially unaligned.

11. The electrical connector of claim 1 wherein said insulator is molded over said center terminal said outer terminal.

12. The electrical connector of claim 11 wherein said center terminal and said outer terminal are non-planar.

13. The electrical connector of claim 12 wherein a center terminal connection feature and an outer terminal connection feature are radially aligned.

14. The electrical connector of claim 12 wherein a center terminal connection feature and an outer terminal connection feature are radially unaligned.
